(19) United States
(12) Patent Application Publication
(10) Pub. No.: US 2004/0131804 A1
(43) Pub. Date: Jul. 8, 2004

(54) Multi-shelled applique, installation template, and method of trial positioning

(76) Inventor: Jay J. Baker, Mayville, NY (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/699,055

(22) Filed: Oct. 31, 2003

Related U.S. Application Data
(60) Provisional application No. 60/422,647, filed on Oct. 31, 2002.

(51) Int. Cl. B60R 13/00

(52) U.S. Cl. 428/31

(57) ABSTRACT

An appliqué is described, as well as a method for mounting it, and a template for accurately placing it in any number of trial locations and a final location. An appliqué is described having a base shell, an outer shell, and one or more intermediate shells. Bases on the outer shell may be connected using shell fasteners to corresponding landings on the base shell. Footings on the base shell may be fastened to a wall using wall fasteners. A template is described for use in placing an appliqué in any number of trial locations on a surface. A method of using a template is disclosed for placing an appliqué in trial locations and in a final location. The template may be part of a consumer package enclosing an appliqué. This Abstract is provided to comply with the rules, which require an abstract to quickly inform a searcher or other reader about the subject matter of the application. This Abstract is submitted with the understanding that it will not be used to interpret or limit the scope or meaning of the claims.

### CROSS-REFERENCE TO RELATED APPLICATIONS

This patent application is a U.S. Non-provisional application filed pursuant to Title 35, U.S.C. §§ 100 et seq. and 37 C.F.R. § 1.53(b), and claiming priority under Title 35, U.S.C. § 119(e) to a U.S. Provisional application bearing Serial No. 60/422,647, filed Oct. 31, 2002, naming Jay J. Baker as the inventor. Both the subject application and its corresponding provisional application have been or are under obligation to be assigned to the same entity.

### BACKGROUND

1. Technical Field

The following disclosure relates generally to the field of

appliqués and, more particularly, to a multi-shelled decorative appliqué, a method for installing it, and a template for accurately placing the appliqué in any number of trial locations and in the final desired location.

2. Description of Related Art

The aftermarket for automotive trim and accessories is significant and growing. Exterior components from bug deflectors and air dams to chrome rocker panels and decorative appliqués are available for installation on cars, trucks, campers, boats, and other vehicles. The market for decorative trim is driven in part by the individual's desire to customize and personalize an otherwise ordinary item.

Many decorative appliqués available today consist of a single plate or shell attached by adhesive to a body panel or other surface. A single-shell appliqué typically has a decorative outer surface and a plain inner surface, a portion of which includes an adhesive. The decorative features of the outer surface are limited to some extent by the need for the overall shape to be durable and structurally sound. The appliqué shell may only have a limited variety of shapes because the inner surface and the overall shell must serve as a supportive structure once the appliqué is applied.

Thus, there is a need in the art for an appliqué assembly that allows designers the freedom to create a variety of decorative outer surfaces without the structural and shape limitations of a standard appliqué.

Most application instructions suggest trying several locations before attaching the appliqué in its final location, but there is no satisfactory method in the art for viewing a location before the decision is finalized. Tasks such as leveling the appliqué and coordinating its location with existing trim and other features are difficult, especially with larger appliqués.

Thus, there exists a need in the art for a method of positioning an appliqué at a variety of non-permanent trial locations where the appliqué can be viewed clearly before the final location decision is made.

### SUMMARY

The following summary is not an extensive overview and is not intended to identify key or critical elements of the apparatuses, methods, systems, processes, and the like, or to delineate the scope of such elements. The summary provides a conceptual introduction in a simplified form as a prelude to the more-detailed description that follows.

Certain illustrative example apparatuses, methods, systems, processes, and the like, are described herein in connection with the following description and the accompanying drawing figures. These examples represent but a few of the various ways in which the principles supporting the apparatuses, methods, systems, processes, and the like, may be employed and thus are intended to include equivalents. Other advantages and novel features may become apparent from the detailed description which follows, when considered in conjunction with the drawing figures.

In one aspect of the present invention, an apparatus may include a base shell and an outer shell joined by one or more shell fasteners. The base shell may have an outer side and a generally opposing wall side facing the wall, the base shell including one or more landings on the outer side. The outer shell may have an outwardly-facing decorative side and a generally opposing inner side facing the wall, the outer shell including one or more bases on the inner side. The one or more bases may correspond in size and location to the one or more landings. The one or more shell fasteners are for attaching the one or more bases to the one or more landings, thereby joining the outer shell to the base shell.

The apparatus may also include one or more footings on the wall side and one or more wall fasteners for attaching the one or more footings to the wall, thereby joining the base shell to the wall.

The apparatus may also include one or more intermediate shells having one or more intermediate bases on an inner surface and one or more intermediate landings on an outer surface. The one or more intermediate bases may correspond in size and location to the one or more landings on the base shell. The one or more intermediate landings may correspond in size and location to the one or more bases on the outer shell. The one or more intermediate fasteners are for attaching the one or more intermediate shells to the base shell.

In one aspect, the one or more footings on the wall side form one or more corresponding channels on the outer side of the base shell, and the one or more landings are interspersed on the outer side between and among the one or more channels.

In another aspect, the base shell and the outer shell may be manufactured by thermoforming.

In another aspect, the base shell and the outer shell, when joined, may define a shell cavity. The base shell and the wall, when joined, may define a base cavity.

In another aspect, the shell fasteners may include segments of foam tape having adhesive on opposing sides protected by a removable lining. The wall fasteners may include segments of foam tape having adhesive on opposing sides protected by a removable film.

In another aspect, the shell fasteners may include segments of a two-part fastening tape joined by a hook side and a loop side configured to provide temporary attachment when pressed together. The hook side may include a hooked surface and an opposing surface having a permanent adhesive protected by a removable layer. The loop side may include a looped surface and an opposing plain surface having a permanent adhesive protected by a removable plain layer.

In another aspect, the wall fasteners may include segments of a two-part fastening tape joined by a hook side and a loop side.

In another aspect of the present invention, an apparatus is provided for facilitating the mounting of an object to a wall surface. The apparatus may include a template having an overall shape and size to generally cover the outer side of the object, the template having at least one generally linear edge; a means for temporarily fastening the template to the wall surface along the edge; and one or more handhold windows through the template, the windows sized and positioned to allow a user to reach through the template, grasp the object, and maneuver the object. The means for temporarily fastening may include a length of masking tape. The template may be part of a retail package containing the object.

In another aspect of the present invention, a method is provided for positioning an object on a wall surface at one or more trial locations. The method may include providing a template having an overall shape and size to generally cover the outer side of the object, the template having at least one generally linear edge and one or more handhold windows therethrough; temporarily fastening the edge to the wall surface at one of the one or more trial locations to form a temporary hinge; opening the template by rotating the template about the temporary hinge and lifting; placing the object inside the template; reaching through the one or more handhold windows and grasping the object; and closing the template with the object inside by rotating the template about the temporary hinge and lowering until the object rests against the wall surface. The step of providing a template may include providing the template as part of a retail package containing the object, and instructing a user to separate the template from the retail package such that the template is ready for use.

In another aspect of the present invention, a method is provided for positioning an object on a wall surface at a final location. The method may include providing a template having an overall shape and size to generally cover the outer side of the object, the template having at least one generally linear edge and one or more handhold windows therethrough; temporarily fastening the edge to the wall surface at one of the one or more trial locations to form a temporary hinge; opening the template by rotating the template about the temporary hinge and lifting; removing the film from the adhesive surfaces; placing the object inside the template; reaching through the one or more handhold windows and grasping the object; and closing the template with the object inside by rotating the template about the temporary hinge and lowering until the one or more adhesive surfaces rest against the wall surface. The step of providing a template may include providing the template as part of a retail package containing the object, and instructing a user to separate the template from the retail package such that the template is ready for use.

These and other objects are accomplished by the apparatuses, methods, and systems disclosed and will become apparent from the following detailed description of a preferred embodiment in conjunction with the accompanying drawings in which like numerals designate like elements.

### BRIEF DESCRIPTION OF THE DRAWING

The invention may be more readily understood by reference to the following description, taken with the accompanying drawing figures, in which:

FIG. 1 is a perspective illustration of an appliqué assembly, according to one embodiment of the present invention.

FIG. 2 is a cross-sectional assembly view of an appliqué assembly, according to one embodiment of the present invention.

FIG. 3 is an illustration of the outer side of a base shell of an appliqué assembly, according to one embodiment of the present invention.

FIG. 4 is a cross-sectional assembly view of an appliqué assembly, affixed to a wall, according to one embodiment of the present invention.

FIG. 5 is an assembly drawing of an appliqué assembly including a base shell, an outer shell, and one or more intermediate shells, according to one embodiment of the present invention.

FIG. 6 is an illustration of a positioning template according to one embodiment of the present invention.

FIG. 7 is an illustration of the inner side of an outer shell of an appliqué assembly, according to one embodiment of the present invention.

### DETAILED DESCRIPTION

The subject matter of this application is related to that of a U.S. Provisional application bearing Serial No. 60/422,647, filed Oct. 31, 2002, which is incorporated herein by reference in its entirety.

To the extent that the term “includes” is employed in the detailed description or the claims, it is intended to be inclusive in a manner similar to the term “comprising” as that term is interpreted when employed as a transitional word in a claim. Further still, to the extent that the term “or” is employed in the claims (for example, A or B) it is intended to mean “A or B or both.” When the author intends to indicate “only A or B but not both,” the author will employ the phrase “A or B but not both.” Thus, use of the term “or” herein is the inclusive use, not the exclusive use.

The system of the present invention is often described herein, by way of example, in the context of its usefulness as an appliqué for motor vehicles. Although the vehicle-related example may be described in considerable detail, it is not the intention of the applicants to restrict or in any way limit the scope of the invention to such detail. Additional uses, applications, advantages, and modifications of the inventive system will be readily apparent to those skilled in the art. Therefore, the invention, in its broader aspects, is not limited to the specific details, the representative apparatus, and illustrative examples shown and described. Accordingly, departures may be made from such details without departing from the spirit or scope of the general inventive concept.

Example apparatuses, methods, systems, processes, and the like, are now described with reference to the drawings, where like reference numerals are used to refer to like elements throughout. In the following description, for purposes of explanation, numerous specific details are set forth in order to facilitate a thorough understanding of the apparatuses, methods, systems, processes, and the like. It may be evident, however, that the apparatuses, methods, systems, processes, and the like, can be practiced without these specific details. In other instances, well-known structures and devices may be shown in block diagram form in order to simplify the description.

Shells

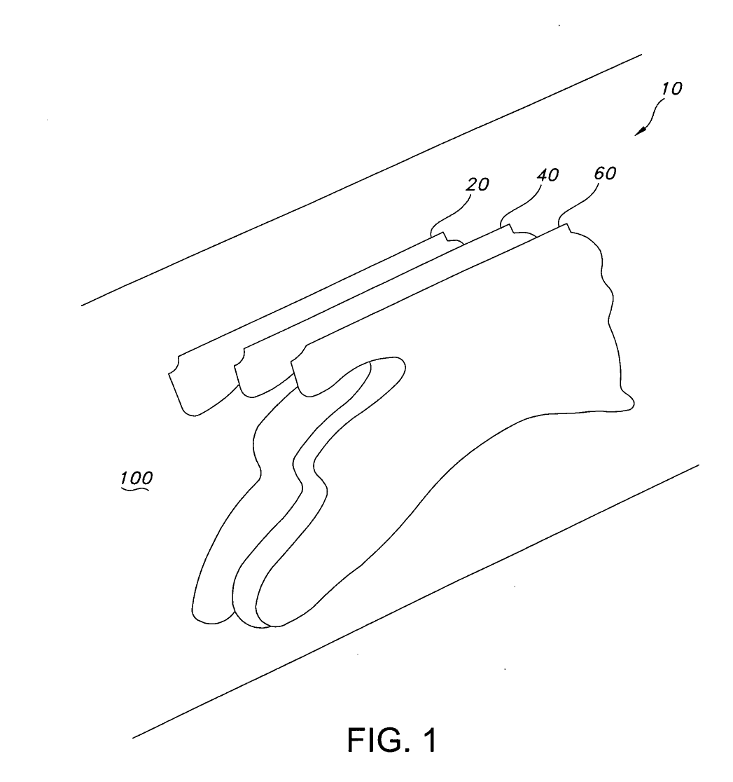

FIG. 1 is a perspective illustration of an appliqué assembly 10 according to one embodiment of the present invention. The appliqué assembly 10 may include two or more parts called shells, including a base shell 20 and an outer shell 60. As shown in FIG. 1, the assembly 10 may include one or more intermediate shells 40. The assembly 10 may be fastened or otherwise attached to a wall 100, such as a side panel of a vehicle.

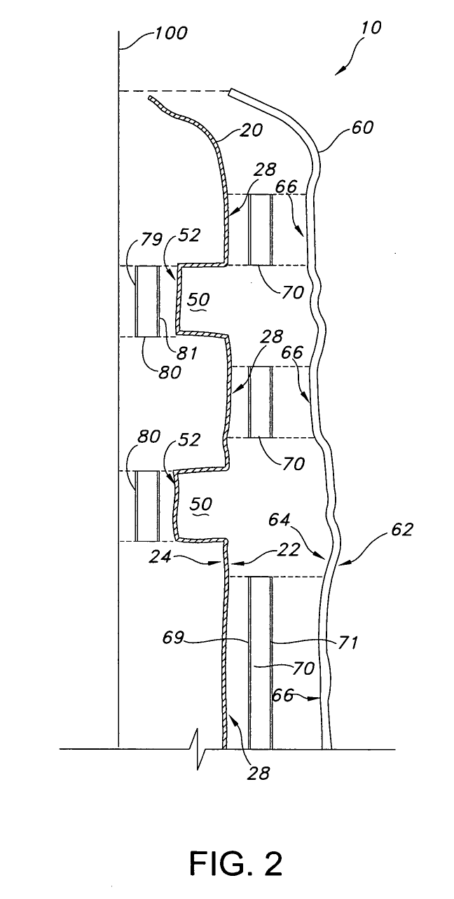

FIG. 2 is a sectional illustration of an appliqué assembly 10 having a base shell 20 and an outer shell 60, according to one embodiment of the present invention. The outer shell 60 may be attached to the base shell 20 by one or more shell fasteners 70. The base shell 20 may be attached to a wall 100 by one or more wall fasteners 80.

In one embodiment, the base shell 20 may provide structural support for the appliqué assembly 10. The base shell 20 may or may not be visible after installation. In this aspect, the outer shell 60 may have a different shape or contour than the base shell 20. The base shell 20 may be constructed to provide structural stability, whereas the outer shell 60 may be constructed to provide a desired ornamental appearance.

The outer shell 60 may have an inner side 64 and an outward-facing decorative side 62. The base shell 20 may have an outer side 22 and an inward-facing wall side 24. Each shell 20, 60 may have any desired thickness. In one embodiment, the shells 20, 60 may be manufactured using a process known as thermoforming.

In the thermoforming process, generally, thermoplastic sheets are heated in an oven to a forming temperature; the heated sheets are then formed under heat and pressure using molds; then, the resulting molded parts are chilled quickly to form a rigid structure that is ready for separation, die-cutting, or other finishing operations. Although other methods may be used, the thermoforming produces a high degree of accuracy, economy, precision, and reproducibility.

In one aspect of the present invention, the shells 20, 60 may have the same general shape. The similar shape of the shells 20, 60 may provide a self-aligning feature for the appliqué assembly 10. During assembly, the base shell 20 may nest within the outer shell 60, to some degree, to achieve a desired alignment. In one aspect, a specific profile for the similarly-shaped shells 20, 60 may allow a single, correct alignment while simultaneously preventing other, improper or undesired alignments during assembly. The precision of thermoforming makes it well-suited for manufacturing the appliqué assembly 10 of the present invention.

Bases and Landings

Attachment between the outer shell 60 and the base shell 20 is made possible in one embodiment by a set of matching bases 66 and landings 28. As shown in FIG. 2, the outer shell 60 may include a group of areas called bases 66 at various locations on the inner side 64 of the outer shell 60. The base shell 20 may include a series of landings 28 on the outer side 22. Each base 66 may be positioned and shaped to match the position and shape of each corresponding landing 28.

The bases 66 and landings 28 may be generally planar and rectangular in shape, in one embodiment, and may be sized to accept a pre-cut segment of fastening tape. Generally flat bases 66 and corresponding landings 28 may be provided, although any variety of different shapes and sizes may be suitable depending on the size and shape of the appliqué assembly 10. For example, the bases 66 and landings 28 may be disposed at an angle with respect to the overall plane of the assembly 10, they may include a textured surface, or they may include a combination of angles and features desired to provide a suitable place for connecting the outer shell 60 to the base shell 20.

In one embodiment, the bases 66 and landings 28 may be distributed across the outer shell 60 and inner shell 20, respectively, to provide support and structural stability for the assembly 10 at specific areas where a need for support is anticipated. For example, a generally elongate assembly 10 may benefit from a corresponding base 66 and landing 28 near the ends of the assembly 10. More complex or elaborate shapes, for example, may benefit from bases 66 and landings 28 distributed in a pattern that places some of the base-landing pairs at generally perpendicular angles with respect to other base-landing pairs, to improve lateral stability. In one embodiment, each base 66 may be attached to each landing 28 using a shell fastener 70.

Channels and Footings

Attachment between the base shell 20 and the wall 100 is made possible in one embodiment by a set of footings 52 located on the wall side 24 of the base shell 20. As shown in FIG. 2, the footings 52 may be formed in the base shell 20 such that the footings 52 extend toward and nearly touch the wall 100. The footings 52 on the wall side 24 of the base shell 20 may create a series of corresponding channels 50 on the opposing outer side 22. The channels 50 may be generally rectangular in cross-section, as depicted in FIG. 2, or they may take any variety of different shapes depending on the size and shape of the appliqué assembly 10. In one embodiment, each footing 52 may be attached to the wall 100 using a wall fastener 80.

In one embodiment, the footings 52 (and channels 50) may be distributed across the inner shell 20 to provide support and structural stability for the assembly 10 at specific areas where a need for support is anticipated. For example, a generally elongate assembly 10 may benefit from a footing 52 near the ends of the assembly 10. More complex or elaborate shapes, for example, may benefit from footings 52 distributed in a pattern that places some of the footings 52 at generally perpendicular angles with respect to other footings 52, to improve lateral stability.

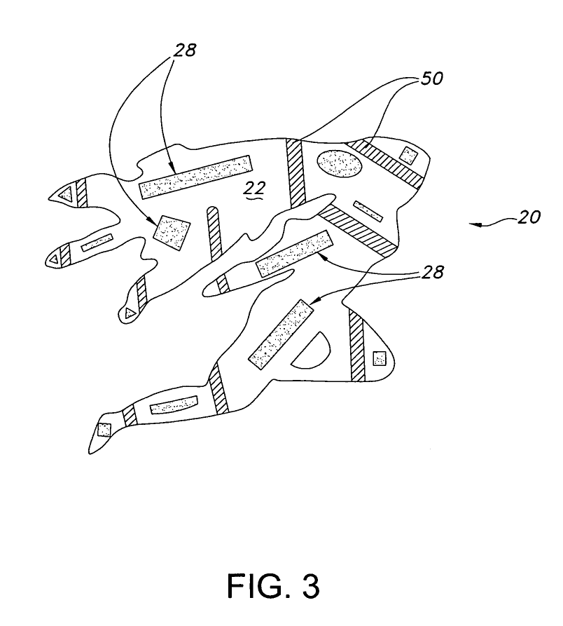

FIG. 3 is a plan view illustration of a base shell 20 according to one embodiment of the present invention. The landings 28 on the outer side 22 of the base shell 20 may be interspersed between and among the channels 50 in such a way as to promote a firm and durable attachment between the shells 20, 60. The size, shape, and location of the channels 50 and landings 28 may vary greatly, depending upon the size, shape, and contour of the appliqué assembly 10 as a whole.

Although the features shown in the cross-section in FIG. 2 appear to be generally parallel and rectilinear, it should be appreciated that the series of landings 28 and channels 50 may be positioned and shaped in a variety of locations and arrays to assure a fast and proper fit between the shells 20, 60. The landings 28 in FIG. 3, for example, include shapes that are square, rectangular, triangular, elliptical, rhomboidal, and irregular.

In FIG. 3, the channels 50 can be seen on the outer side 22 of the base shell 20. In one embodiment, pieces of shell fastener 70 may be affixed to the landings 28 on the base shell 20. The channels 50 may be oriented in a variety of directions and may have a variety of shapes and sizes tailored to fit the overall shape of the appliqué assembly 10.

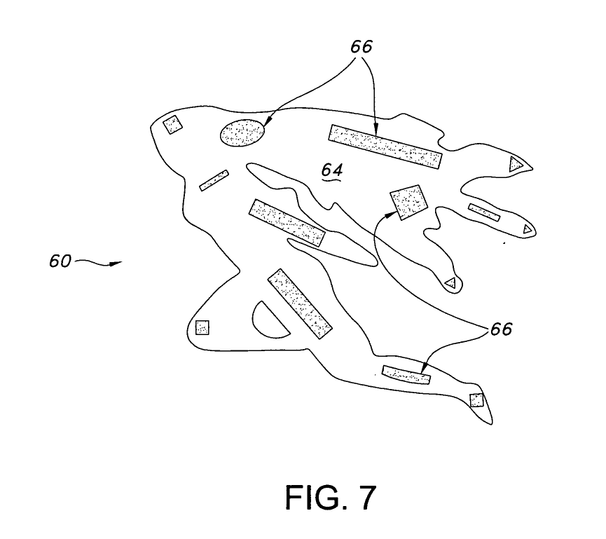

The bases 66 on the inner side 64 of the outer shell 60 are illustrated in FIG. 7. A side-by-side comparison of FIG. 7 and FIG. 3 shows how the bases 66 generally match the landings 28, in size, shape, and location. As shown in FIG. 7, the bases 66 on outer shell 60 may be interspersed in such a way as to promote a firm and durable attachment between the shells 20, 60.

Fasteners

Referring again to FIG. 2, the shell fasteners 70 and wall fasteners 80 in one embodiment may be constructed of one piece or many pieces. The thickness of the fasteners 70, 80 in FIG. 2 is exaggerated for clarity. The fasteners 70, 80 may provide a permanent, temporary, or semi-permanent attachment. The fasteners 70, 80 may include a removable protective lining or film covering one or more adhesive surfaces.

The fasteners 70, 80 may be provided in die-cut shapes specifically designed to fit onto the footings 52, landings 28, and bases 66 of a particular appliqué assembly 10. Die-cut pieces may be numbered or otherwise coded to ensure selection of the appropriate fastener 70, 80 for the position. Alternatively, a sheet or length of material may be provided, from which the user may cut fasteners 70, 80 to fit the particular footings 52, landings 28, and bases 66. In this aspect, the fasteners 70, 80 for the appliqué assembly 10 of the present invention may be die-cut in advance or custom-fit by the user in the field, or both, depending upon the particular appliqué assembly 10 and the expected skill level of the user.

In one embodiment, the fasteners 70, 80 may be made of foam tape with adhesive on both sides. The shell fasteners 70 may include an inner lining 69 and/or an outer lining 71 covering the opposing adhesive surfaces, as shown in FIG. 1. The adhesives may be permanent or semi-permanent, and may be pressure-sensitive. Similarly, the wall fasteners 80 may include an inner film 79 and an outer film 81 on the opposing adhesive surfaces. The linings 69, 71 and films 79, 81 protect the adhesive until the user is ready to join the shells 20, 60 or affix the base shell 20 to a wall 100.

Acrylic foam tape has been developed for the attachment of exterior trim and components onto painted automotive surfaces. Foam tape has replaced mechanical fasteners like screws, rivets, and clips as the method preferred by Original Equipment Manufacturers (OEMs) for mounting aftermarket accessories to painted surfaces. The semi-flexible acrylic foam core allows the tape to expand or contract when exposed to stress and other physical forces, as well as environmental forces exerted by wind, water, and extreme temperatures. Moreover, the foam core is sufficiently flexible to accommodate differential forces when the tape is used to join two dissimilar surfaces. When used with the present invention, for example, a thermoformed plastic base shell 60 and a painted metal wall 100 may react very differently to physical and environmental forces. The different coefficients of thermal expansion, for example, may cause the shell 60 and the wall 100 to expand or contract differently in response to temperature changes. A fastener having a flexible foam core may allow movement between the surfaces without distorting the shell 60, tearing or peeling the tape, or otherwise causing a failure of the fastener.

Although the appliqué assembly 10 is described herein as being well suited for a wall 100, it should be understood and it will be appreciated by one skilled in the art that the appliqué assembly 10 of the present invention is also well suited for installation on a non-planar surface such as the curvilinear side panel of a boat or an automobile. In particular, the plastic thermoforming process, which is one method of manufacturing the assembly 10, may produce a pair of shells 20, 60 that are sufficiently flexible yet durable enough to withstand the stresses and strains of installation on a curved surface. In fact, for custom applications on highly-contoured surfaces, the thermoforming and cooling process may be customized to produce a semi-rigid appliqué assembly 10 having the same curvature as the surface upon which it will be installed.

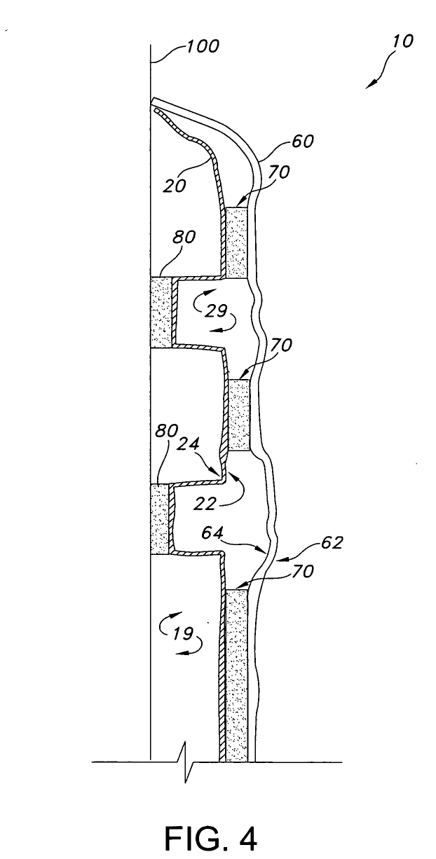

The cross-sectional view illustrated in FIG. 2 is shown assembled and installed in FIG. 4. In its installed position, the appliqué assembly 10 may be anchored to the wall 100 by the wall fasteners 80. A shell cavity 29 may exist between the shells 20, 60. Similarly, a base cavity 19 may exist between the base shell 20 and the wall 100 after the appliqué assembly 10 is attached.

In one embodiment, only the wall fasteners 80 may be in contact with the wall 100 after installation. The shells 20, 60 may rest very close to the wall 100 or, in one embodiment, may be in contact with the wall 100.

In one embodiment, the perimeter edge of the base shell 20 may not be in contact with the wall 100, while the perimeter edge of the outer shell 60 may touch the wall 100 providing a finished look. Using the precision offered by the thermoforming process, the perimeter edges of the shells 20, 60 may be sized and shaped to form an attractive and non-abrasive fit against the wall 100.

The attachment of the appliqué assembly 10 to the wall 100 may or may not create a water-tight or airtight seal. The assembly 10 may permit water to exit and may facilitate a flow of air beneath the shells 20, 60 to avoid vehicle corrosion, rust, or other damage. In a related aspect, the shells 20, 60 of the present invention may be sufficiently flexible to permit installation on a curved surface.

Using foam tape for the fasteners 70, 80, as described above, may provide a degree of flexibility desired for installation on curved surfaces. Also, the foam core may be sufficiently permeable to withstand the intrusion of water into the fasteners 70, 80 without causing the tape to fail. A tape with a foam core can dry, whereas a solid-core tape might peel or fail when exposed to environmental elements.

Temporary Fasteners

In one embodiment, the fasteners 70, 80 may be temporary. A two-piece hook and loop closure system, for example, such as the Velcro® brand nylon hook and loop fastener, may provide a secure yet temporary attachment. The hook side may include small, flexible hooks that engage with small, soft loops of fabric on the matching loop side when the two sides are pressed together.

Two-part fasteners 70, 80 may include adhesive backing suitable for permanent attachment of the two parts to opposing surfaces. Like double-sided tape, the adhesive on the two parts of the temporary shell fasteners 70 may include an inner lining 69 and an outer lining 71 to protect the adhesive surfaces. Similarly, the wall fasteners 80 may include an inner film 79 and an outer film 81 on the opposing adhesive surfaces. The linings 69, 71 and films 79, 81 protect the adhesive until the user is ready to join the shells 20, 60 or affix the appliqué assembly 10 to a wall 100.

In use, either the hook portion of the loop portion of the fastener 70, 80 may be affixed to either side of the pieces to be joined. For example, the hook portion of the shell fastener 70 may be attached to either a landing 28 or a base 66, with the loop portion attached to the opposing area. Similarly, the hook portion of the wall fastener 80 may be attached to either a footing 52 or to the wall 100, with the loop portion attached to the opposing area.

In one embodiment, a mixture of permanent and temporary fasteners 70, 80 may be used, depending on the particular intended use for the appliqué assembly 10, the user's needs, or other factors. The shells 20, 60, for example, may be permanently joined using adhesive shell fasteners 70, while the attachment between the base shell 20 and the wall 100 may be made temporary by the use of hook-and-loop wall fasteners 80.

In another aspect of the invention, an appliqué assembly 10 may be designed for use by children and young adults. An appliqué assembly 10 of the present invention may be installed on a stroller, tricycle, wagon, bicycle, pedal car, or any number of motorized and non-motorized play vehicles. An appliqué assembly 10 may also be installed on generally stationary items such as doors, walls, desks, tables, mirrors, windows, tubs or showers, tree-houses, play sets, or any other structure having a suitable surface for mounting. The temporary fasteners 70, 80 may be particularly well-suited for this type of application.

Decorative Applications

In another aspect of the invention, the shells 20, 60 may be opaque, transparent, or semi-transparent, depending upon the desired decorative effect. The thermoforming process, for example, may allow the use of a wide variety of colors and patterns that may be permanently imprinted on one or both sides of a thermoplastic sheet. Metallic films, retro-reflective linings, and holographic images represent a few of the alternatives available for use with the appliqué assembly 10. The imprinted image may be, for example, a photograph, an advertisement, a business name, a sports team, or any variety of images. Also, combinations of transparent and semi-transparent shells 20, 60 may create a desirable decorative effect. Transparent shells 20, 60 may be desired in order to reveal the underlying color of the wall 100.

In one embodiment, the base cavity 19 or the shell cavity 29 (shown in FIG. 4) may be filled with a neutral or colored foam or similar additive material for additional durability or decorative effect. The shells 20, 60 may be designed and formed to provide various compartments within the cavities 19, 29 to hold different additives having different colors or textures. The variety of colors, patterns, shapes, and textures suitable for the appliqué assembly 10 of the present invention is only limited by the imagination.

In another aspect of the invention, a transparent or semi-transparent outer shell 60 may be provided which is suitable for painting or staining by the user. An outer shell 60 of the present invention may include an imprinted paint-by-number pattern, a coloring book type pattern, a blank area for free-form expression, or any combination of these where the user may apply paints or stains. The paints or stains may be applied to one or more of the inner sides of the appliqué assembly 10 to protect the design from the elements. Users of all ages may desire the extra level of personalization offered by such an outer shell 60.

The appliqué assembly 10 may also include a supply of colored shapes or objects that may be placed inside the appliqué assembly 10 before installation. Such objects may be made of thermoformed plastic sheets, for example, sized and shaped to fit within or between the shells 20, 60 of the appliqué assembly 10. Any of a variety of shapes or objects may be provided, including images of animals, flowers, figures, cartoon characters, team logos, letters, names, words, numbers, or any such item of interest to a particular user.

For applications where one or more decorative elements may be changed by the user, the temporary fasteners 70, 80 may be desired. The appearance of the appliqué assembly 10 may be changed for any reason or no reason, including changes in age, topics of interest, artistic ability, or time of year. Users of all ages may appreciate the ability to change the appearance of the appliqué assembly 10, for example, to keep pace with current trends in the automotive trim and accessories market.

Multiple Shells

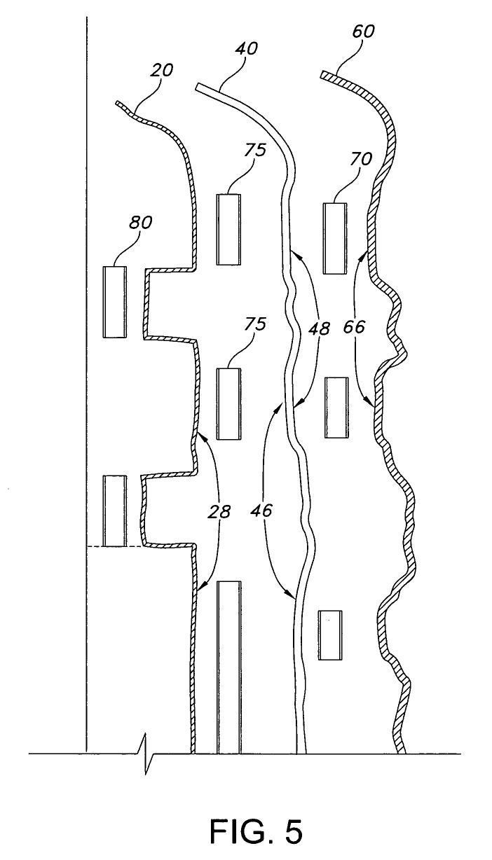

In one embodiment, the appliqué assembly 10 of the present invention may include multiple shells: a base shell 20, an outer shell 60, and one or more intermediate shells 40, as shown in FIG. 5. An intermediate shell 40 may include a series of intermediate landings 48 positioned and shaped to match the bases 66 on the outer shell 60. The intermediate shell 40 may also include a series of intermediate bases 46 positioned and shaped to match the landings 28 on the base shell 20. Intermediate fasteners 75 may be used to connect the intermediate shell 40 with adjacent shells.

The addition of one or more intermediate shells 40 may be desired for a variety of reasons, including increased durability, enhanced decorative effect, or improved structural stability for large or complex appliqués, to name a few. The use of several intermediate shells 40 may require matching intermediate landings 48 and intermediate bases 46 between and among the several shell layers, for attachment and alignment.

Method of Assembly

In another aspect, the present invention includes a method for assembling the shells 20, 60 of an appliqué assembly 10 using shell fasteners 70. In one aspect of the method, the outer shell 60 may be attached to the base shell 20 first. To do so, the user may remove one or more protective linings 69, 71 (shown in FIG. 1) and attach the shell fasteners 70 to the landings 28 on the base shell 20 (or, alternatively, to the bases 66 on the outer shell 60) and press the shells 20, 60 together to fasten them. The generally self-aligning shape of the shells 20, 60 may assist the user in achieving a proper alignment between the shells 20, 60. If one or more intermediate shells 40 are present, the method of the present invention may involve joining the shells in series using one or more intermediate fasteners 75. Having thus joined the shells 20, 40, 60 together, the user now has an appliqué assembly 10 ready to install on a wall 100 or other surface.

Installation Template

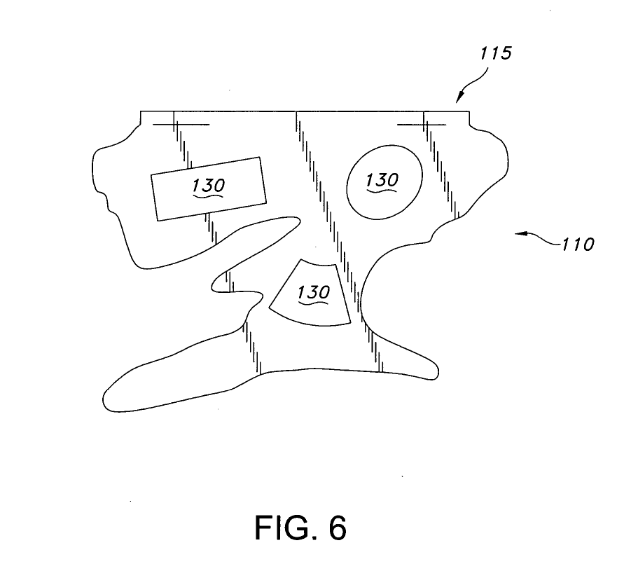

In another aspect, the present invention may include a template 110 in one embodiment constructed from the consumer packaging of the appliqué assembly 10. In this aspect, the template 110 (shown in FIG. 6) may be cut from the package by following a pattern, such as an imprinted dotted line. The template 110 may be transparent to facilitate viewing objects inside. The pattern for the template 110 may be shaped to match the general outline of the appliqué assembly 10 and may include a generally linear edge 115 and one or more handhold windows 130.

The term “generally linear edge” as used herein refers to an edge 115 of the template 110 that is suitable for use as a temporary hinge. The edge 115 may include two points or short segments, spaced apart, which together are sufficient to define a line about which the template 110 may be rotated. Because two points are sufficient to define a line, a generally linear edge may include two points. A generally linear edge may also include, of course, a series of spaced-apart yet collinear segments or a continuous rectilinear edge, or any combination thereof.

The template 110 shown in FIG. 6 includes three handhold windows 130 having different shapes and sizes. Like the template 110 itself, the windows 130 may be cut from the package by following a pattern. The windows 130 may be positioned in different locations on the template 110 to allow the user to grasp certain parts of the appliqué assembly 10 during installation. The size, shape, and location of the windows 130 may be tailored to fit the needs of the size and shape of the assembly 10. The handhold windows 130 of the present invention may provide the user with access grasp the assembly 10 being held inside the shell of the template 110 for improved control and accurate positioning.

The edge 115 of the template 110 may provide a suitable place for the user to attach the template 110 to the wall 100 where the appliqué assembly 10 will be placed. Using temporary masking tape, for example, the user may attach the template 110 to the wall 100 along the edge 115. The taped edge 115 may now act as a hinge, for opening and closing the template 110. The generally linear shape of the edge 115 provides a suitable surface for a working hinge, although edges 115 having other, non-linear shapes may be used. In this aspect, the template 110 of the present invention provides a new and useful apparatus for positioning an appliqué assembly 10 in a desired location.

Method of Trial Positioning

In another aspect, the present invention includes a method for positioning the appliqué assembly 10 at a variety of non-permanent trial locations where it can be viewed—without attaching it to a wall 100—before the final location decision is made. The method involves the use of the inventive template 110 of the present invention.

The user may attach the wall fasteners 80 to the footings 52 of the base shell 20, without removing the inner films 79 (shown in FIG. 1) on the wall side, so that the appliqué assembly 10 may be viewed without attaching it to the wall 100.

The hinge described above allows the user to open or lift the template 110 away from the wall 100, rotating the template about the line defined by the edge 115. In one embodiment, the edge 115 may be temporarily fastened to the wall 100 using a temporary adhesive tape, such as masking tape, or by any other suitable method. The user may then place the appliqué assembly 10 inside the template 110, and then close or lower the template 110 back toward the wall 100 until the appliqué assembly 10 rests against the surface of the wall 100. With the inner films 79 in place, protecting the inner adhesive, the appliqué assembly 10 may rest against the wall 100 without sticking. In this aspect, the template 110 holds the appliqué assembly 10 in a temporary location on the wall 100 for viewing by the user. In fact, for applications to the wall 100 of a motor vehicle, the vehicle may be driven at low speeds to judge the appearance of the appliqué assembly 10 in the trial location.

In a further aspect of the method, the hinged edge 115 of the template 110 may provide the user with accurate positioning and attachment of the appliqué assembly 10 in its final location. When the user is confident about the final location, the template 110 may be opened and the appliqué assembly 10 may be grasped through the handhold windows 130 and lifted away from the wall 100 as the template 110 is opened. Once open, the inner films 79 on the wall fasteners 80 may be removed to expose the adhesive. Then, using the handhold windows 130 to grasp the appliqué assembly 10, the user can slowly and carefully close the template 110 toward the wall 100, gently placing the appliqué assembly 10 against the wall 100 and pressing firmly to set the fasteners 80. After installation, the hinged template 110 maybe removed.

It should be understood that the designs and apparatuses disclosed herein are scalable. The methods and systems of the present invention may be applied in other fields or to facilitate the installation of very large or very small ornaments. Furthermore, the types of ornamentation shown and disclosed herein are used for descriptive purposes, as a way of illustrating the present invention and its potential applications, and should not be construed as a limitation on the invention's applicability or suitability for alternative uses.

The described embodiments of the invention are intended to be merely exemplary. Numerous variations and modifications will be apparent to those skilled in the art. All such variations and modifications are intended to fall within the scope of the present invention as defined in the appended claims.

What has been described above includes several examples. It is, of course, not possible to describe every conceivable combination of components or methodologies for purposes of describing the systems, methods, and apparatuses that may be employed using the technology disclosed. However, one of ordinary skill in the art may recognize that further combinations and permutations are possible. Accordingly, this application is intended to embrace alterations, modifications, and variations that fall within the scope of the appended claims. Furthermore, the preceding description is not meant to limit the scope of the invention. Rather, the scope of the invention is to be determined only by the appended claims and their equivalents.

While the systems, methods, and apparatuses herein have been illustrated by describing examples, and while the examples have been described in considerable detail, it is not the intention of the applicants to restrict or in any way limit the scope of the appended claims to such detail. Additional advantages and modifications will be readily apparent to those skilled in the art. Therefore, the invention, in its broader aspects, is not limited to the specific details, the representative systems and methods, or illustrative examples shown and described. Accordingly, departures may be made from such details without departing from the spirit or scope of the applicant's general inventive concepts.

What is claimed is:

1. An apparatus comprising:
a base shell having an outer side and a generally opposing wall side facing said wall, said base shell including one or more landings on said outer side;
an outer shell having an outwardly-facing decorative side and a generally opposing inner side facing said wall, said outer shell including one or more bases on said inner side, said one or more bases corresponding in size and location to said one or more landings; and
one or more shell fasteners for attaching said one or more bases to said one or more landings, thereby joining said outer shell to said base shell.

2. The apparatus of claim 1, further comprising:
one or more footings on said wall side;
one or more wall fasteners for attaching said one or more footings to said wall, thereby joining said base shell to said wall.

3. The apparatus of claim 1, further comprising:
one or more intermediate shells having one or more intermediate bases on an inner surface and one or more intermediate landings on an outer surface,
said one or more intermediate bases corresponding in size and location to said one or more landings on said base shell, and
said one or more intermediate landings corresponding in size and location to said one or more bases on said outer shell; and
one or more intermediate fasteners for attaching said one or more intermediate shells to said base shell.

4. The apparatus of claim 2, wherein said one or more footings on said wall side form one or more corresponding channels on said outer side of said base shell,
and wherein said one or more landings are interspersed on said outer side between and among said one or more channels.

5. The apparatus of claim 1, wherein said base shell and said outer shell are manufactured by thermoforming.

6. The apparatus of claim 2, wherein said base shell and said outer shell, when joined, define a shell cavity,
and wherein said base shell and said wall, when joined, define a base cavity.

7. The apparatus of claim 1, wherein said shell fasteners comprise segments of foam tape having adhesive on opposing sides protected by a removable lining.

8. The apparatus of claim 2, wherein said wall fasteners comprise segments of foam tape having adhesive on opposing sides protected by a removable film.

9. The apparatus of claim 1, wherein said shell fasteners comprise segments of a two-part fastening tape joined by a hook side and a loop side configured to provide temporary attachment when pressed together,
said hook side comprising a hooked surface and an opposing surface having a permanent adhesive protected by a removable layer, and
said loop side comprising a looped surface and an opposing plain surface having a permanent adhesive protected by a removable plain layer.

10. The apparatus of claim 2, wherein said wall fasteners comprise segments of a two-part fastening tape joined by a hook side and a loop side configured to provide temporary attachment when pressed together,
said hook side comprising a hooked surface and an opposing surface having a permanent adhesive protected by a removable layer, and
said loop side comprising a looped surface and an opposing plain surface having a permanent adhesive protected by a removable plain layer.

11. An apparatus for facilitating the mounting of an object to a wall surface, comprising:
a template having an overall shape and size to generally cover the outer side of said object, said template having at least one generally linear edge;
a means for temporarily fastening said template to said wall surface along said edge; and
one or more handhold windows through said template, said windows sized and positioned to allow a user to reach through said template, grasp said object, and maneuver said object.

12. The apparatus of claim 11, wherein said means for temporarily fastening comprises a length of masking tape.

13. The apparatus of claim 11, wherein said template before use forms part of a retail package containing said object.

14. A method of positioning an object on a wall surface at one or more trial locations, comprising:
providing a template having an overall shape and size to generally cover the outer side of said object, said template having at least one generally linear edge and one or more handhold windows therethrough;
temporarily fastening said edge to said wall surface at one of said one or more trial locations to form a temporary hinge;
opening said template by rotating said template about said temporary hinge and lifting;
placing said object inside said template;
reaching through said one or more handhold windows and grasping said object; and
closing said template with said object inside by rotating said template about said temporary hinge and lowering until said object rests against said wall surface.

15. The method of claim 14, wherein said step of providing a template comprises:
providing said template as part of a retail package containing said object; and
instructing a user to separate said template from said retail package such that said template is ready for use.

16. A method of mounting an object having one or more adhesive surfaces protected by a removable film onto a wall surface at a final location, said method comprising:
providing a template having an overall shape and size to generally cover the outer side of said object, said template having at least one generally linear edge and one or more handhold windows therethrough;
temporarily fastening said edge to said wall surface at one of said one or more trial locations to form a temporary hinge;
opening said template by rotating said template about said temporary hinge and lifting;
removing said film from said adhesive surfaces;
placing said object inside said template;
reaching through said one or more handhold windows and grasping said object; and
closing said template with said object inside by rotating said template about said temporary hinge and lowering until said one or more adhesive surfaces rest against said wall surface.

17. The method of claim 16, wherein said step of providing a template comprises:
providing said template as part of a retail package containing said object; and
instructing a user to separate said template from said retail package such that said template is ready for use.
